(19) United States
(12) Patent Application Publication
(10) Pub. No.: US 2017/0214781 A1
(43) Pub. Date: Jul. 27, 2017

(54) NON-TRANSITORY COMPUTER READABLE STORAGE MEDIUM, REMOTE OPERATION SUPPORTING METHOD, AND INFORMATION PROCESSING APPARATUS

(71) Applicant: DENSO CORPORATION, Kariya-city, Aichi-pref. (JP)

(72) Inventors: Takashi ICHIDA, Kariya-city (JP); Masaya ITO, Kariya-city (JP); Masaya TAKATSUJI, Kariya-city (JP); Yoshitaka OZAKI, Kariya-city (JP); Hiroki UKAI, Kariya-city (JP)

(21) Appl. No.: 15/329,263

(22) PCT Filed: Sep. 22, 2015
(86) PCT No.: PCT/JP2015/004819

§ 371 Date: Jan. 26, 2017

(30) Foreign Application Priority Data
Oct. 3, 2014 (JP) 2014-204929

(51) Int. Cl. H04M 1/725; H04M 1/60

(52) U.S. Cl. CPC H04M 1/7253; H04M 1/72583; H04M 1/72569; H04M 1/6091; H04M 1/72525

(57) ABSTRACT

A remote operation supporting program installed in an information processing apparatus into which multiple compatible programs corresponding to a remote operation apparatus and multiple incompatible programs not corresponding to the remote operation apparatus are installed, the information processing apparatus executing one program selected by user operation among installed compatible and incompatible programs, includes: controlling the information processing apparatus to function as a detection unit that detects the compatible programs from the installed compatible and incompatible programs; and controlling the information processing apparatus to function as a first display control unit that displays a list of the compatible programs detected by the detection unit on a display unit of the information processing apparatus.

### CROSS REFERENCE TO RELATED APPLICATION

This application is based on Japanese Patent Application No. 2014-204929 filed on Oct. 3, 2014, the disclosure of which is incorporated herein by reference.

### TECHNICAL FIELD

The present disclosure relates to a remote operation supporting program and a remote operation supporting method to support a remote operation apparatus in manipulating an information processing apparatus and relates to an information processing apparatus where the remote operation supporting program is installed.

### BACKGROUND ART

There is widely known an information processing apparatus that enables installation of a plurality of programs and is capable of executing a program selected by a user out of the installed programs.

An example of the information processing apparatus is available as a smartphone. As disclosed in patent literature 1, there is also known a remote operation apparatus that remotely manipulates an information processing apparatus. In patent literature 1, the remote operation apparatus is described as a remote electronic apparatus. A portable electronic apparatus is disclosed as the information processing apparatus.

According to patent literature 1, the remote electronic apparatus transmits data to the portable electronic apparatus. The portable electronic apparatus specifies an application in the portable electronic apparatus to process the data.

As disclosed in patent literature 1, it is necessary to specify an application (i.e., a program) stored in the information processing apparatus to process data from the remote operation apparatus. The specified program needs to include a function capable of processing data from the remote operation apparatus.

Many programs are usually installed in the information processing apparatus such as a smartphone. Many programs may include a program (hereinafter referred to as an incompatible program) that does not include a function to process data from the remote operation apparatus.

Undoubtedly, the information processing apparatus may be installed with a plurality of programs (hereinafter referred to as compatible programs) that includes a function to process data from the remote operation apparatus.

Therefore, it is necessary to select one compatible program to be manipulated by the remote operation apparatus out of a plurality of programs installed in the information processing apparatus in order to manipulate the information processing apparatus via the remote operation apparatus.

Many programs may be installed and include compatible programs and incompatible programs mixed with each other. Selecting one compatible program requires recognizing which of many programs are compatible.

The information processing apparatus such as a smartphone normally displays a list of executable programs using icons. Therefore, a user feels inconvenient to start a compatible program because the user needs to determine which of many icons correspond to a compatible program or an incompatible program. The user may spend a long time to look fixedly at the screen until finding an intended icon corresponding to the compatible program.

Therefore, there is a need to quickly find an intended icon corresponding to the compatible program. In a vehicle, a driver is supposed to manipulate the information processing apparatus using the remote operation apparatus. It is necessary to minimize the time for the driver to look fixedly at the information processing apparatus.

### PRIOR ART LITERATURES

### Patent Literature

Patent Literature 1: JP-2013-535123 T

### SUMMARY OF INVENTION

It is an object of the present disclosure to provide a remote operation supporting program, a remote operation supporting method, and an information processing apparatus that support reducing inconvenient manipulation until finding an intended compatible program corresponding to a remote operation apparatus and shortening the time to look fixedly at the information processing apparatus.

According to a first aspect of the present disclosure, a remote operation supporting program installed in an information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs, the remote operation supporting program includes: controlling the information processing apparatus to function as a detection unit that detects the compatible programs from the compatible programs and the incompatible programs installed in the information processing apparatus; and controlling the information processing apparatus to function as a first display control unit that displays a list of the compatible programs detected by the detection unit on a display unit of the information processing apparatus.

According to the remote operation supporting program, the first display control unit allows the display unit to display a list of compatible programs. A user can search the list for a compatible program to be started and eliminate the need to determine whether the program contained in the list is a compatible program. Therefore, the user can reduce inconvenient manipulation until finding an intended compatible application and shorten the time to look fixedly at the display unit of the information processing apparatus.

According to a second aspect of the present disclosure, a remote operation supporting method for supporting a selection operation of selecting one compatible program in an information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs installed, the remote operation supporting method includes: detecting the compatible programs from the compatible programs and the incompatible programs installed in the information processing apparatus; and displaying a list of detected compatible programs on a display unit of the information processing apparatus.

According to a third aspect of the present disclosure, in an information processing apparatus, the remote operation supporting program according to the first aspect is installed.

According to a fourth aspect of the present disclosure, an information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs installed, the information processing apparatus includes: a detection unit that detects the compatible programs from installed compatible programs and installed incompatible programs; a display unit; and a first display control unit that displays a list of the compatible programs detected by the detection unit on the display unit.

The remote operation supporting method and the information processing apparatus described above can also provide the same effect as the remote operation supporting program.

### BRIEF DESCRIPTION OF DRAWINGS

The above and other objects, features and advantages of the present disclosure will become more apparent from the following detailed description made with reference to the accompanying drawings. In the drawings:

FIG. 1 is a configuration diagram illustrating a remote operation system including a smartphone as an information processing apparatus according to the present disclosure;

FIG. 2 is a configuration diagram illustrating the smartphone in FIG. 1;

FIG. 3 is a diagram illustrating an application selection screen displayed on a display unit;

FIG. 4 is a flowchart illustrating a process performed by a launcher application in the background;

FIG. 5 is a drawing illustrating compatible application information acquired from a server;

FIG. 6 is a flowchart illustrating a process performed by the launcher application at startup;

FIG. 7 is a diagram illustrating a list of installed compatible applications displayed on the display unit;

FIG. 8 is a diagram illustrating a Setup icon displayed in the list of installed compatible applications;

FIG. 9 is a setup image displayed when the Setup icon is selected;

FIG. 10 is a flowchart illustrating a process performed when an App installation image unit is selected;

FIG. 11 is a diagram illustrating a list of all compatible applications; and

FIG. 12 is a display example illustrating that a compatible application is already installed.

### EMBODIMENTS FOR CARRYING OUT INVENTION

Embodiments of the present disclosure will be described with reference to the accompanying drawings.

(Overall Configuration)

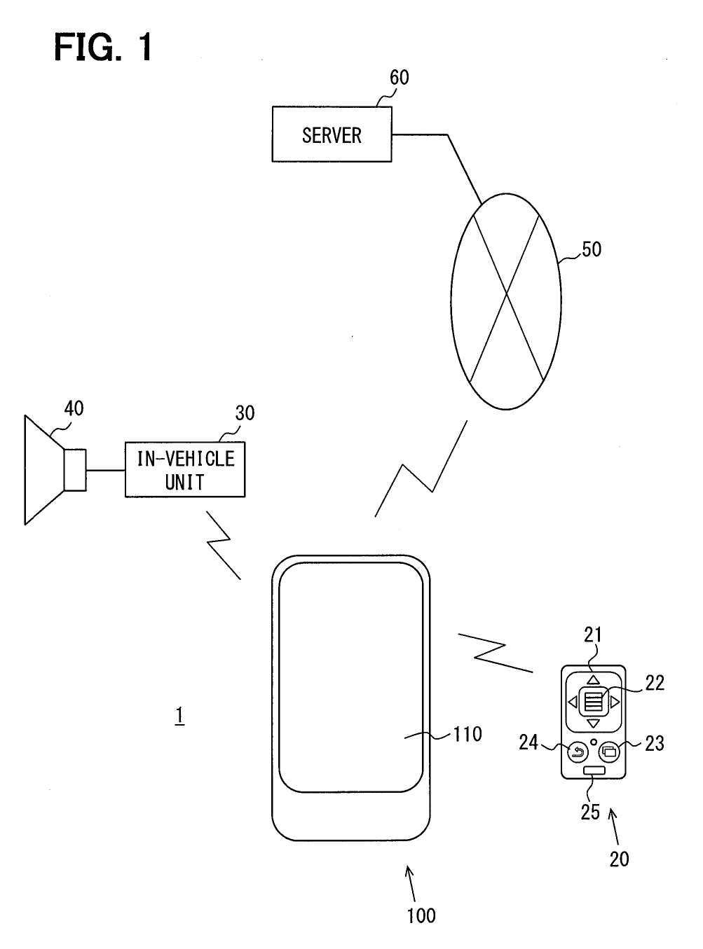

A remote operation system 1 illustrated in FIG. 1 is used in a vehicle and includes a smartphone 100 as an information processing apparatus according to the disclosure, a remote operation device 20, an in-vehicle unit 30, and a speaker 40. As publicly known, the smartphone 100 is capable of communication with other instruments via a public communication network 50. According to the embodiment, the smartphone 100 communicates with a server 60 via the public communication network 50.

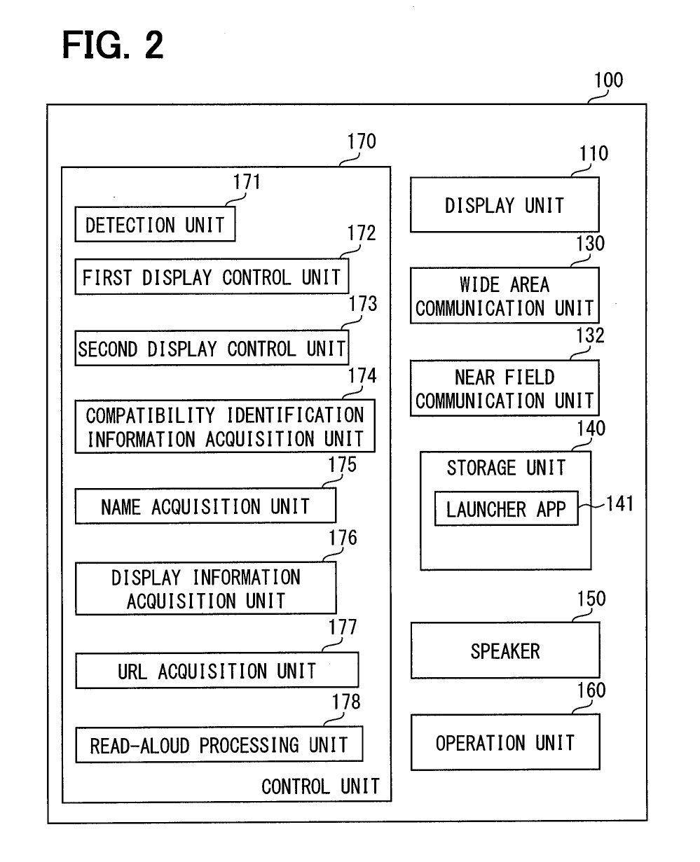

The smartphone 100 includes a display unit 110. The display unit 110 displays various icons 120 representing programs. According to the embodiment, the program is hereinafter referred to as an application. The other configurations of the smartphone 100 will be described later with reference to FIG. 2.

The remote operation device 20 corresponds to a remote operation apparatus. The remote operation device 20 according to the embodiment includes a cross-hair button 21, a scroll wheel 22, a menu button 23, a back button 24, and a connection button 25.

The cross-hair button 21 can enter four directions such as top, bottom, right, and left. The scroll wheel 22 rotates around a shaft and moves in the thickness direction of the remote operation device 20. The remote operation device 20 transmits a scroll signal to a wirelessly connected instrument when the scroll wheel 22 rotates around the shaft in response to user manipulation. The scroll wheel 22 moves in the thickness direction of the remote operation device 20 to perform a selection operation.

Manipulating the menu button 23 allows the display unit 110 of the smartphone 100 to display a list of applications compatible with the remote operation device 20 or a menu screen. Manipulating the back button 24 returns an image displayed on the display unit 110 of the smartphone 100 to an image that was displayed before the currently displayed image. Pressing the connection button 25 makes wireless connection between the remote operation device 20 and an instrument to be operated remotely. The remote operation device 20 includes a communication unit inside. Pressing the connection button 25 uses the communication unit to establish wireless connection with an instrument to be connected based on the near field wireless communication. The wireless connection uses a system in compliance with the wireless standard such as Bluetooth Low Energy, for example. Bluetooth is a registered trademark.

For example, the in-vehicle unit 30 is available as an in-vehicle audio instrument and is connected to the speaker 40. The in-vehicle unit 30 communicates with the smartphone 100 and outputs audio from the speaker 40 based on audio data transmitted from the smartphone 100.

The server 60 stores various types of information (hereinafter referred to as compatible application information) about a compatible application (i.e., a compatible program) that is installed in the smartphone 100 and can be operated from the remote operation device 20. The compatible application information will be described in detail later.

(Configuration of the Smartphone 100)

As illustrated in FIG. 2, the smartphone 100 includes a display unit 110, a wide area communication unit 130, a near field communication unit 132, a storage unit 140, a speaker 150, an operation unit 160, and a control unit 170.

The display unit 110 displays an icon 120 corresponding to each application installed in the smartphone 100. The icon 120 represents either or both text and a graphic other than text.

The wide area communication unit 130 wirelessly connects with the public communication network 50 for communication. The near field communication unit 132 performs wireless communication based on the same communication system as the remote operation device 20.

The storage unit 140 includes a writable, nonvolatile storage medium such as flash memory. The storage unit 140 stores an application installed in the smartphone 100. The application is classified into a compatible application compatible with the remote operation device 20 and an incompatible application the remote operation device 20 cannot operate. The storage unit 140 stores a launcher application 141 corresponding to a remote operation supporting program.

The speaker 150 outputs audio that reads out the name of a compatible application. The operation unit 160 includes a touch panel overlaid on the surface of the display unit 110. The operation unit 160 may include a touch switch or a mechanical switch placed around the display unit 110.

The control unit 170 is available as a computer including a CPU, ROM, and RAM. The CPU performs the launcher application 141 stored in the storage unit 140 while using a temporary storage function of the RAM. The control unit 170 thereby functions as a detection unit 171, a first display control unit 172, a second display control unit 173, a compatibility identification information acquisition unit 174, a name acquisition unit 175, a display information acquisition unit 176, a URL acquisition unit 177, and a read-aloud processing unit 178. One or more ICs as hardware may configure all or part of the functions implemented by the control unit 170.

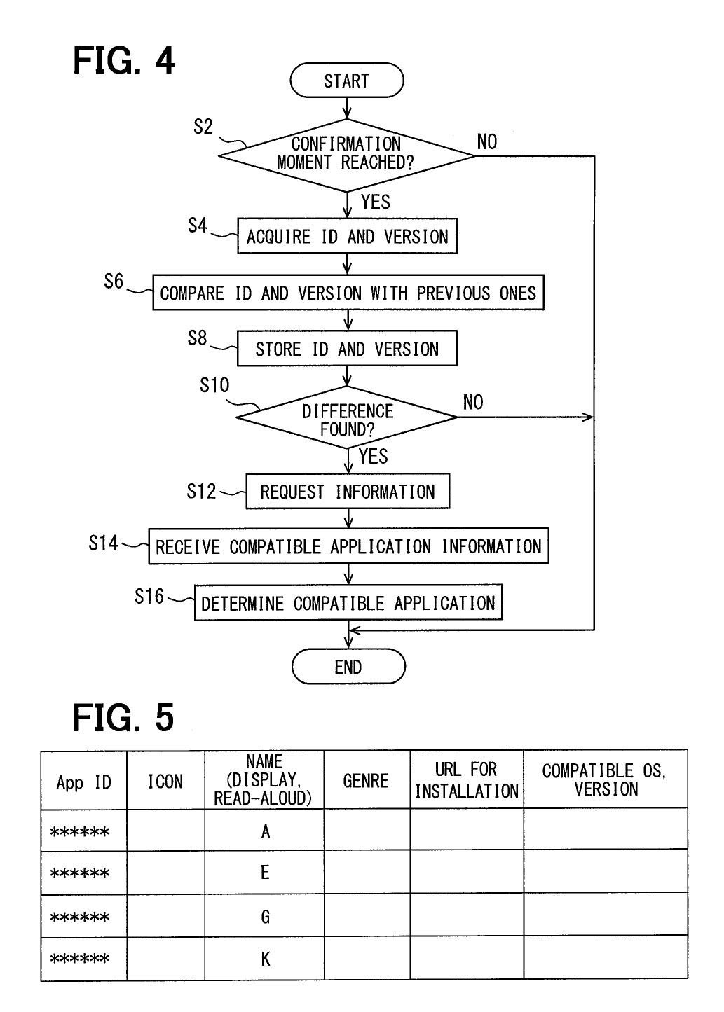

Processes on the detection unit 171, the first display control unit 172, the second display control unit 173, the compatibility identification information acquisition unit 174, the name acquisition unit 175, the display information acquisition unit 176, the URL acquisition unit 177, and the read-aloud processing unit 178 will be described with reference to FIG. 4 and later.

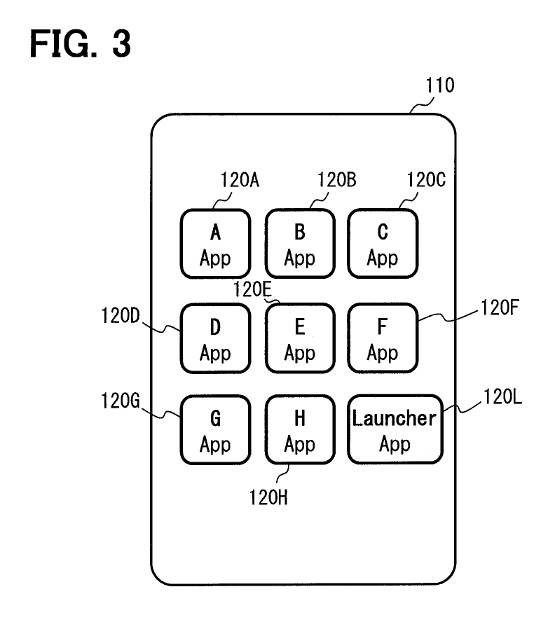

FIG. 3 illustrates an application selection screen displayed on the display unit 110. The application selection screen displays the icon 120 corresponding to each application installed in the smartphone 100. The example in FIG. 3 displays icons 120A through 120H corresponding to applications A through H and icon 120L corresponding to the launcher application 141. The icon 120L, when touched by a user, starts the launcher application 141.

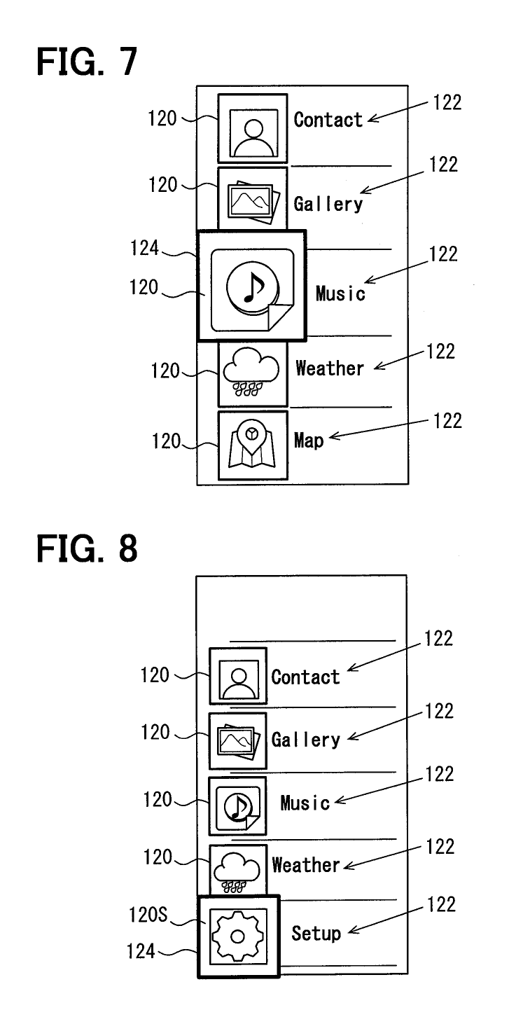

The icons 120A through 120H and 120L in FIG. 3 are provided as graphics surrounding the text with a frame for the purpose of illustration. However, it is unquestionably possible to use the icon 120 in FIG. 7 that uses a graphic other than text to simply represent the meaning of an application.

(Processes of Control Unit 170)

When activated, the launcher application 141 periodically performs a process in FIG. 4. The compatibility identification information acquisition unit 174, the name acquisition unit 175, the display information acquisition unit 176, and the URL acquisition unit 177 perform S12 in FIG. 4. The detection unit 171 performs the other processes, namely, S2 through S10, S14, and S16. S2 through S10, S14, and S16 correspond to a detection task.

At S2, the process determines whether a confirmation moment is reached to determine whether a compatible application is installed in the smartphone 100. The confirmation moment occurs each time the launcher application 141 starts and a subsequent specified interval elapses. The specified interval can be defined appropriately so as to cover several days, for example.

The process in FIG. 4 terminates if determining that the confirmation moment is not reached (S2: NO). The process proceeds to S4 if determining that the confirmation moment is reached (S2: YES).

At S4, the process inquires of an operating system of the smartphone 100 to acquire application IDs and application versions of all applications installed in the smartphone 100.

At S6, the process compares the application ID and the application version acquired at S4 with the application ID and the application version previously acquired at S4. The application ID and the application version previously acquired at S4 are stored in the storage unit 140 when the process performs S8 to follow during previous execution of the process in FIG. 4.

At S8, the process allows the storage unit 140 to store the application ID and the application version acquired at S4.

At S10, the process determines whether the comparison result at S6 indicates a difference. The process in FIG. 4 terminates if determining that the comparison result indicates no difference (S10: NO). The process proceeds to S12 if determining that the comparison result indicates a difference (S10: YES).

At S12, the process uses the wide area communication unit 130 to transmit a request signal requesting the compatible application information to the server 60. The request signal also includes a model of the smartphone 100, a type and a version of the operating system, and a model and a version of the remote operation device 20. Whether the remote operation device 20 can operate a compatible application may depend on a difference among these items of information.

The server 60 stores the compatible application information about a plurality of compatible applications. The compatible application information provides various types of information about a compatible application.

As conceptually illustrated in FIG. 5, the compatible application information specifically includes an application ID, an icon, a name, a genre, a URL for installation, a compatible operating system and its version. The name includes a name for display and a name for reading aloud. Whether the remote operation device 20 is available for operation may depend on the remote operation device 20, its version, a model of the smartphone 100, and its version. In such a case, the compatible application information also includes the compatible remote operation device 20, its version, the model of the smartphone 100, and its version.

Of these, the application ID, the compatible remote operation device 20, the version, the model of the smartphone 100, and the version correspond to compatibility identification information acquired by the compatibility identification information acquisition unit 174. The icon and the name for display correspond to program specification information acquired by the display information acquisition unit 176. The name acquisition unit 175 acquires the name for reading aloud. The URL acquisition unit 177 acquires the URL for installation.

The server 60 acquires the request signal from the smartphone 100 and then determines a compatible application available for a combination of the smartphone 100 to have transmitted the request signal and the remote operation device 20 connected to the smartphone 100. The server 60 transmits the compatible application information about the determined compatible application to the smartphone 100 that transmitted the request signal.

At S14 in FIG. 4, the process receives the compatible application information transmitted from the server 60. The process stores the received compatible application information in the storage unit 140.

At S16, the process determines whether the application installed in the smartphone 100 is compatible or incompatible, based on the compatible application information received at S14.

The process in FIG. 4 is performed periodically because a new application is installed in the smartphone 100 as needed and the installed application is updated as needed.

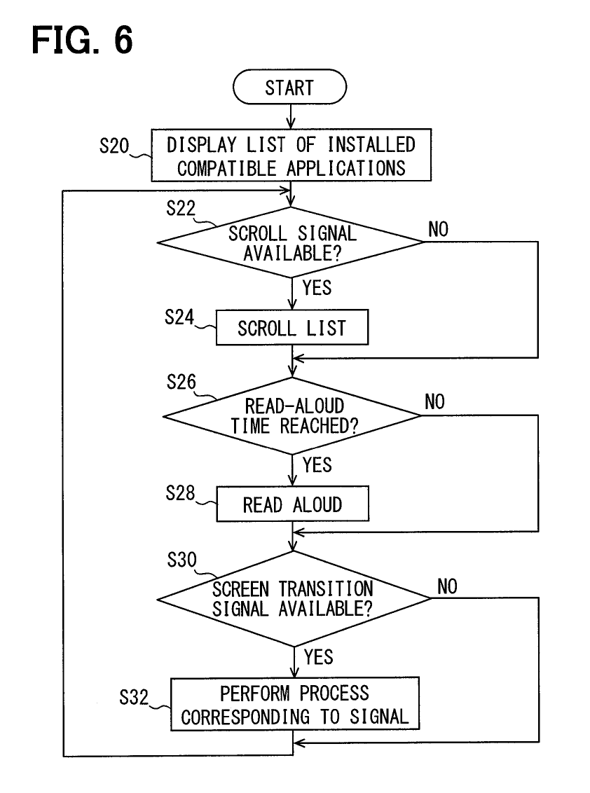

A process in FIG. 6 is also performed when the launcher application 141 starts. The first display control unit 172 performs S20 through S24, S30, and S32 in FIG. 6. The read-aloud processing unit 178 performs S26 and S28. S20 through S24, S30, and S32 correspond to a display control task.

At S20, the process allows the display unit 110 to display a list of all compatible applications that are already installed in the smartphone 100. The list is hereinafter referred to as a list of installed compatible applications. Performing the process in FIG. 4 determines which of the applications installed in the smartphone 100 is compatible or incompatible.

FIG. 7 partially illustrates the list of installed compatible applications. The display unit 110 of the smartphone 100 is not so large and, in many cases, may not be able to display the complete list of installed compatible applications at a time. As illustrated in FIG. 7, the display unit 110 partially displays the list of installed compatible applications when the complete list of installed compatible applications cannot be displayed at a time.

The list of installed compatible applications in FIG. 7 displays the icon 120 of the compatible application and the name 122 of the compatible application. The icon 120 and the name 122 of the compatible application are extracted from the compatible application information stored in the storage unit 140 at S14.

At S22, the process determines whether a scroll signal is input from the remote operation device 20. The remote operation device 20 transmits the scroll signal when the scroll wheel 22 of the remote operation device 20 is rotated. The remote operation device 20 may transmit the scroll signal when the cross-hair button 21 is manipulated upward or downward.

The process proceeds to S24 if the determination at S22 results in YES. At S24, the process scrolls the list of installed compatible applications displayed on the display unit 110 in the direction and by the amount determined by the scroll signal. The process proceeds to S26 after performing S24 or if the determination at S22 results in NO.

At S26, the process determines whether the time to continue selecting the selected icon 120 reaches a read-aloud time. According to the embodiment, as illustrated in FIG. 7, the selected icon 120 is surrounded by a selection frame 124 and is displayed more largely than the unselected icon 120. At S26, the process determines whether the time elapsed from the selection of the icon 120 reaches the read-aloud time. The process proceeds to S28 if the determination results in YES.

At S28, the process allows the predetermined one of or both the speaker 150 of the smartphone 100 and the speaker 40 mounted on the vehicle to output the audio resulting from reading aloud the name of the compatible application represented by the selected icon 120.

The audio resulting from reading aloud the name of the compatible application can be generated by using the name for reading aloud included in the compatible application information stored in the storage unit 140 at S14 and a publicly known speech production application that can generate the audio from the name.

The process proceeds to S30 after performing S28 or if the determination at S26 results in NO. At S30, the process determines whether a screen transition signal is input from the remote operation device 20. Specifically, the screen transition signal corresponds to a selection signal generated by manipulating the scroll wheel 22 in the thickness direction, a back signal generated by pressing the back button 24, or a menu display signal generated by pressing the menu button 23.

The process proceeds to S32 if the determination at S30 results in YES. At S32, the process performs a process corresponding to the input signal. The process then returns to S22. The process returns to S22 without proceeding to S32 if the determination at S30 results in NO.

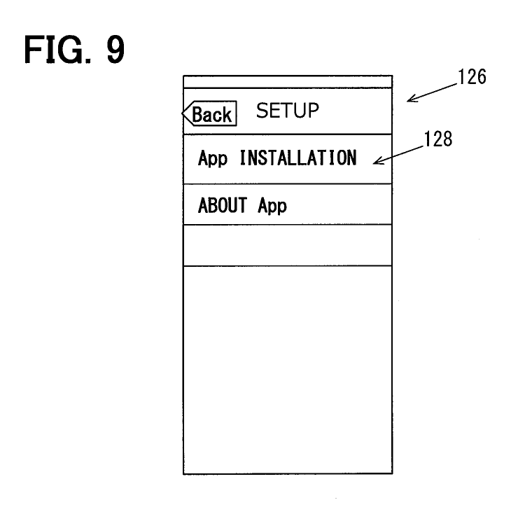

As illustrated in FIG. 8, the embodiment displays a Setup icon 120S at one end of the list of installed compatible applications. The control unit 170 allows the display unit 110 to display a setup image 126 as illustrated in FIG. 9 when a selection signal is input while the icon 120S is selected.

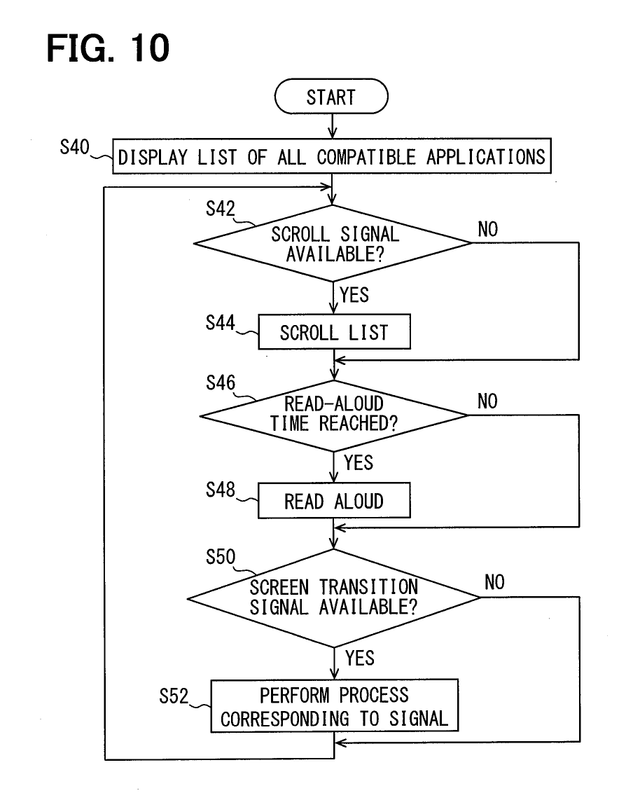

The control unit 170 performs a process illustrated in FIG. 10 when an App installation image unit 128 is selected from the setup image 126 due to user manipulation. The second display control unit 173 performs S40 through S44, S50, and S52 in FIG. 10. The read-aloud processing unit 178 performs S46 and S48.

At S40, the process allows the display unit 110 to display a list of all compatible applications. The list of all compatible applications indicates all compatible applications contained in the compatible application information acquired from the server 60 at S14.

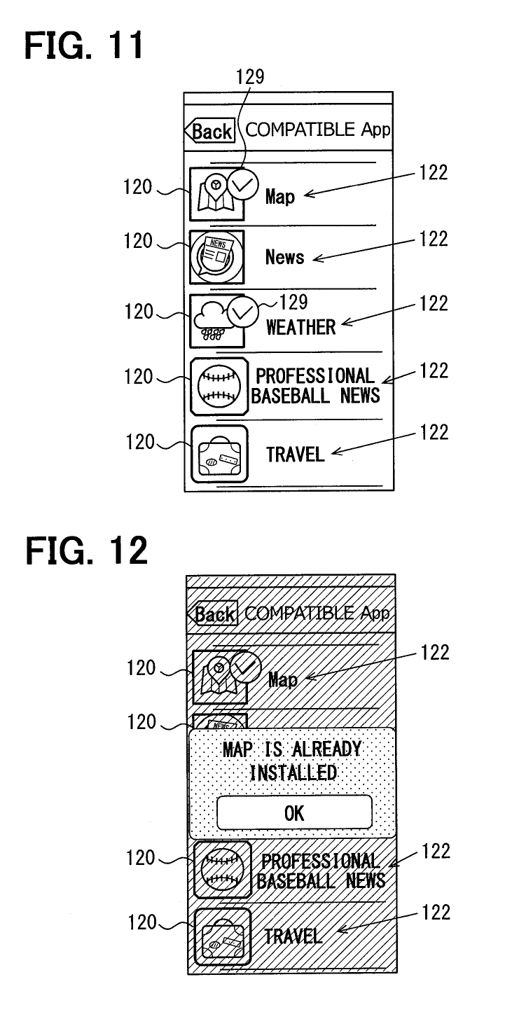

FIG. 11 illustrates the list of all compatible applications. As illustrated in FIG. 11, the list of all compatible applications is similar to the list of installed compatible applications and indicates the icon 120 and the name 122 of a compatible application.

However, unlike the list of installed compatible applications, the list of all compatible applications contains a compatible application installed in the smartphone 100 and a compatible application not installed in the smartphone 100. For this reason, an installation completion mark 129 is attached to the installed compatible application to identify that the compatible application is installed in the smartphone 100. The name 122 of the installed compatible application is displayed in a color lighter than a color used for the name 122 of an uninstalled compatible application.

S42 through S50 equal S22 through S30 in FIG. 6. Suppose that any one of compatible applications is selected and the selected compatible application is installed. At S52, as illustrated in FIG. 12, the process displays a message indicating that the selected compatible application is already installed.

The selected compatible application may be not installed. In this case, the process determines a URL of a site where the compatible application can be downloaded. The process determines the URL from the compatible application information acquired from the server 60. The process allows the display unit 110 to display a screen for the site corresponding to the determined URL.

### Effects of the Embodiment

According to the above-mentioned embodiment, the launcher application 141 is installed in the smartphone 100. When the launcher application 141 starts, the detection unit 171 detects a compatible application corresponding to the remote operation device 20 from applications installed in the smartphone 100 (FIG. 4). The display unit 110 displays the list of installed compatible applications that contains only installed compatible applications (FIG. 7).

The list of installed compatible applications can be used to search for a compatible application intended to start and eliminate the need to determine whether the application indicated by the icon 120 and the name 122 is compatible. Therefore, the embodiment can reduce inconvenient manipulation until finding an intended compatible application and shorten the time to look fixedly at the display unit 110 of the smartphone 100.

The embodiment uses the compatible application information received from the server 60 to detect a compatible application from applications installed in the smartphone 100 (S16). The embodiment can accurately detect a compatible application from installed applications by providing a quick response to the compatible application that is likely to be updated as needed.

The specified speaker 40 or 150 outputs audio resulting from reading aloud the name of the compatible application represented by the icon 120 when the time to continue selecting the same icon 120 in the list of installed compatible applications reaches the read-aloud time (S28). A user can recognize which compatible application is selected without viewing the display unit 110. This can also shorten the time to look fixedly at the display unit 110.

The audio resulting from reading aloud the name of the compatible application is generated based on the name for reading aloud contained in the compatible application information acquired from the server 60. Therefore, the speaker 40 or 150 can output the audio resulting from reading aloud the name of the compatible application even if the operating system of the smartphone 100 does not provide the launcher application 141 with compatible application names.

The compatible application information received from the server 60 contains the icon 120 and the name 122 of a compatible application displayed in the list of installed compatible applications (S14). Therefore, the list of installed compatible applications can be created even if the operating system of the smartphone 100 does not provide the launcher application 141 with the icon 120 and the name 122 of the compatible application.

The compatible application information is acquired from the server 60 as needed. The embodiment can quickly respond to a case where the icon 120 of the compatible application is updated.

The embodiment acquires all items of compatible application information corresponding to the smartphone 100 and the remote operation device 20 from the server 60 out of the compatible application information stored in the server 60. The display unit 110 displays the list of all compatible applications based on the acquired information. The list of all compatible applications uses the installation completion mark 129 to identify whether each compatible application is installed in the smartphone 100. A user can quickly know a compatible application not installed in the smartphone 100 by using the displayed list of all compatible applications.

The display unit 110 displays the screen for a site where the compatible program represented by the icon 120 can be downloaded when the compatible program is not installed in the smartphone 100 and the icon 120 representing the compatible program is selected from the list of all compatible applications. The user can easily install a new compatible application.

While there have been described the embodiments of the present disclosure, the disclosure is not limited to the above-mentioned embodiments. Embodiments described below are also included in the technical scope of the disclosure. Furthermore, the disclosure may be embodied in various modifications without departing from the spirit and scope of the disclosure.

<First Modification>

For example, the display unit 110 may display a list of only compatible applications not installed in the smartphone 100 instead of or in addition to the list of all compatible applications according to the embodiment. In this case, the display unit 110 can display the list of installed compatible applications and the list of only compatible applications not installed in the smartphone 100 interchangeably with each other.

<Second Modification>

Difference information may be included in the request signal at S12 in FIG. 4. The server 60 may transmit only the compatible application information about a compatible application corresponding to the difference information to the smartphone 100. The process in FIG. 6 can be performed also in this case.

There may be the need to display the list of all compatible applications or the list of compatible applications not installed in the smartphone 100. In such a case, all items of the compatible application information about compatible applications available for a combination of the smartphone 100 and the remote operation device 20 may be acquired from the server 60.

<Third Modification>

The above-mentioned embodiment uses the smartphone 100 as the information processing apparatus. The information processing apparatus may be provided as a navigation system or a tablet computer. The navigation system may be fixed to a mobile object such as a vehicle or may be portable. The display unit and the communication unit may be separated from each other when the navigation system is fixed to the mobile object.

<Fourth Modification>

The remote operation device is not limited to the above-mentioned embodiment. For example, the remote operation device may be cylindrical and allow its top to rotate relatively to the bottom around a shaft. The remote operation device may be placed at a steering system. A general-purpose remote controller may be used as the remote operation device.

It is noted that a flowchart or the processing of the flowchart in the present application includes sections (also referred to as steps), each of which is represented, for instance, as S2. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A non-transitory computer readable storage medium including a remote operation supporting program product installed in an information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs, the remote operation supporting program product comprising instructions for execution by a computer, the instructions comprising:
controlling the information processing apparatus to function as a detection unit that detects the compatible programs from the compatible programs and the incompatible programs installed in the information processing apparatus; and
controlling the information processing apparatus to function as a first display control unit that displays a list of the compatible programs detected by the detection unit on a display unit of the information processing apparatus.

2. The non-transitory computer readable storage medium according to claim 1, wherein:
the remote operation supporting program product is installed in the information processing apparatus including a communication unit that communicates with a server;
the instructions further comprising:
controlling the information processing apparatus to function as a compatibility
identification information acquisition unit that acquires compatibility identification information to identify the compatible programs from the server via the communication unit; and
controlling the information processing apparatus to operate the detection unit to detect the compatible programs based on the compatibility identification information acquired by the compatibility identification information acquisition unit.

3. The non-transitory computer readable storage medium according to claim 1, the instructions further comprising:
controlling the information processing apparatus to function as a read-aloud processing unit that outputs a voice sound for reading aloud a name of one compatible program from a specified speaker when the one compatible program is selected from the list of the compatible programs displayed on the display unit.

4. The non-transitory computer readable storage medium according to claim 3, wherein:
the remote operation supporting program product is installed in the information processing apparatus including a communication unit that communicates with a server,
the instructions further comprising:
controlling the information processing apparatus as a name acquisition unit that acquires the name of the one compatible program from the server via the communication unit, the one compatible program being included in the list of the compatible programs displayed on the display unit; and
controlling the information processing apparatus to operate the read-aloud processing unit to output the voice sound for reading aloud the name of the one compatible program from the specified speaker based on the name of the one compatible program acquired by the name acquisition unit.

5. The non-transitory computer readable storage medium according to claim 1, wherein:
the remote operation supporting program product is installed in the information processing apparatus including a communication unit that communicates with a server;
the instructions further comprising:
controlling the information processing apparatus to function as a display information acquisition unit that acquires program specification information from a server via a communication unit, the program specification information being at least one of a name and an icon of each compatible program detected by the detection unit; and
controlling the information processing apparatus to operate the first display control unit to display a list of the program specification information acquired by the display information acquisition unit on the display unit.

6. The non-transitory computer readable storage medium according to claim 2, the instructions further comprising:
controlling the compatibility identification information acquisition unit to repeatedly acquire the compatibility identification information from the server when the remote operation supporting program product is activated.

7. The non-transitory computer readable storage medium according to claim 5, the instructions further comprising:
controlling the display information acquisition unit to acquire all the program specification information corresponding to the information processing apparatus and the remote operation apparatus from the server, the program specification information being stored in the server; and
controlling the information processing apparatus to function as a second display control unit that displays all the program specification information acquired by the display information acquisition unit on the display unit based on a detection result from the detection unit in such a manner that a compatible program installed in the information processing apparatus is distinguished from a compatible program not installed in the information processing apparatus.

8. The non-transitory computer readable storage medium according to claim 7, the instructions further comprising:
controlling the second display control unit to display all the program specification information acquired by the display information acquisition unit in one list on the display unit in such a manner that the compatible program installed in the information processing apparatus is distinguished from the compatible program not installed in the information processing apparatus.

9. The non-transitory computer readable storage medium according to claim 7, the instructions further comprising:
controlling the second display control unit to display all the program specification information acquired by the display information acquisition unit on the display unit in such a manner that a list of the compatible program installed in the information processing apparatus and a list of the compatible program not installed in the information processing apparatus are switchably displayed.

10. The non-transitory computer readable storage medium according to claim 7, the instructions further comprising:
controlling the information processing apparatus to function as a URL acquisition unit that acquires a URL of a site for downloading the compatible program not installed in the information processing apparatus from the server; and
controlling the second display control unit to determine the URL of the site for downloading the compatible program indicated by selected one item of program specification information based on the URL acquired by the URL acquisition unit, and to display a screen of the site corresponding to a determined URL on the display unit when one item of program specification information is selected by user operation in a state where the program specification information of the compatible program not installed in the information processing apparatus is displayed.

11. A remote operation supporting method for supporting a selection operation of selecting one compatible program in an information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs installed, the remote operation supporting method comprising:
detecting the compatible programs from the compatible programs and the incompatible programs installed in the information processing apparatus; and
displaying a list of detected compatible programs on a display unit of the information processing apparatus.

12. The remote operation supporting method according to claim 11, further comprising:
communicating with a server; and
acquiring compatibility identification information to identify the compatible program from the server, wherein:
in the detecting of the compatible programs, the compatible programs are detected based on acquired compatibility identification information.

13. The remote operation supporting method according to claim 11, further comprising:
outputting a voice sound for reading aloud a name of one compatible program from a specified speaker when the one compatible program is selected from the list of the compatible programs displayed on the display unit.

14. The remote operation supporting method according to claim 13, further comprising:
communicating with a server; and
acquiring the name of the one compatible program from the server, the compatible program being included in the list of the compatible programs displayed on the display unit, wherein:
in the outputting of the voice sound, the specific speaker outputs the voice sound for reading aloud the name of the one compatible program based on acquired name of the one compatible program.

15. The remote operation supporting method according to claim 11, further comprising:
communicating with a server;
acquiring program specification information from the server, the program specification information being at least one of a name and an icon of each compatible program detected in the detecting of the compatible program; and
displaying a list of the program specification information on the display unit.

16. The remote operation supporting method according to claim 12, wherein:
in the acquiring of the compatibility identification information, the compatibility identification information is repeatedly acquired from the server.

17. The remote operation supporting method according to claim 15, further comprising:
acquiring all the program specification information corresponding to the information processing apparatus and the remote operation apparatus from the server, the program specification information being stored in the server; and
displaying all acquired program specification information on the display unit based on a detection result in the detecting of the compatible programs with distinguishing a compatible program installed in the information processing apparatus from a compatible program not installed in the information processing apparatus.

18. The remote operation supporting method according to claim 17, wherein:
in the displaying of all the acquired program specification information, all the acquired program specification information is displayed in one list on the display unit with distinguishing the compatible program installed in the information processing apparatus from the compatible program not installed in the information processing apparatus.

19. The remote operation supporting method according to claim 17, comprising
in the displaying of all the acquired program specification information, all the acquired program specification information is displayed on the display unit in such a manner that a list of the compatible program installed in the information processing apparatus and a list of the compatible program not installed in the information processing apparatus are switchably displayed.

20. The remote operation supporting method according to claim 17, further comprising:
acquiring a URL of a site for downloading the compatible program not installed in the information processing apparatus from the server;
determining the URL of the site for downloading the compatible program indicated by selected one item of program specification information based on acquired URL when one item of the program specification information is selected by user operation in a state where the program specification information of the compatible program not installed in the information processing apparatus is displayed; and
displaying a screen of the site corresponding to a determined URL on the display unit.

21. An information processing apparatus into which the remote operation supporting program product in the non-transitory computer readable storage medium according to claim 1 is installed.

22. An information processing apparatus into which a plurality of compatible programs corresponding to a remote operation apparatus and a plurality of incompatible programs not corresponding to the remote operation apparatus are installed, the information processing apparatus executing one program selected by user operation among installed compatible programs and installed incompatible programs installed, the information processing apparatus comprising:
a detection unit that detects the compatible programs from installed compatible programs and installed incompatible programs;
a display unit; and
a first display control unit that displays a list of the compatible programs detected by the detection unit on the display unit.
